(19) United States
(12) Patent Application Publication
(10) Pub. No.: US 2026/0000205 A1
(43) Pub. Date: Jan. 1, 2026

(54) CUSHION ASSEMBLY

(71) Applicant: Lear Corporation, Southfield, MI (US)

(72) Inventors: David HALE, Northville, MI (US); Christopher D. JOHNSON, Novi, MI (US); Bradley C. DUNCAN, Harrison Township, MI (US)

(21) Appl. No.: 18/755,652

(22) Filed: Jun. 26, 2024

(51) Int. Cl. A47C 7/16; A47C 7/24; B29C 65/00; B29C 65/08; B29L 31/00; B60N 2/64; B60N 2/68

(52) U.S. Cl. CPC A47C 7/16; A47C 7/24; B29C 66/69; B29C 65/08; B29L 2031/771; B60N 2/64; B60N 2/68

(57) ABSTRACT

A cushion is provided with a filament mesh member and a fastener strip. The filament mesh member is provided with a set of filaments of thermoplastic material, wherein each member of the set of filaments is bonded to at least one other member of the set of filaments. The fastener strip is welded to the filament mesh member. An aperture is formed into a first surface of the filament mesh member, spaced apart from the fastener strip.

### TECHNICAL FIELD

Various embodiments relate to a cushion assembly and a method of manufacturing a cushion.

### BRIEF DESCRIPTION OF THE DRAWINGS

FIG. 1 is a perspective view of an example of a seat assembly including a filament mesh structure.

FIG. 2 is a schematic view of an example of a manufacturing system for making the filament mesh structure.

FIG. 3 is a perspective view of a cushion of the seat assembly of FIG. 1.

FIG. 4 is another perspective view of the cushion of FIG. 3.

FIG. 5 is a bottom view of a trim cover of the seat assembly of FIG. 1.

FIG. 6 is a perspective view of a cushion of the seat assembly of FIG. 1, in cooperation with a cutting tool, illustrating a step of a manufacturing method according to an embodiment.

FIG. 7 is a perspective view of the cushion of FIG. 6, in cooperation with a welding tool, illustrating another step of the manufacturing method.

FIG. 8 is a perspective view of the cushion of FIG. 6, in cooperation with the welding tool of FIG. 7, illustrating another step of the manufacturing method.

FIG. 9 is a perspective view of the cushion of FIG. 6, in cooperation with the welding tool of FIG. 7, illustrating another step of the manufacturing method.

### DETAILED DESCRIPTION

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

It is to be understood that the disclosed embodiments are merely exemplary and that various and alternative forms are possible. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ embodiments according to the disclosure.

“One or more” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first fastener could be termed a second fastener, and, similarly, a second fastener could be termed a first fastener, without departing from the scope of the various described embodiments. The first fastener and the second fastener are both fasteners, but they are not the same fastener.

The terminology used in the description of the various described embodiments herein is for the purpose of describing particular embodiments only and is not intended to be limiting. As used in the description of the various described embodiments and the appended claims, the singular forms “a” and “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes.” “including,” “comprises,” and/or “comprising” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting.” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition of event],” depending on the context.

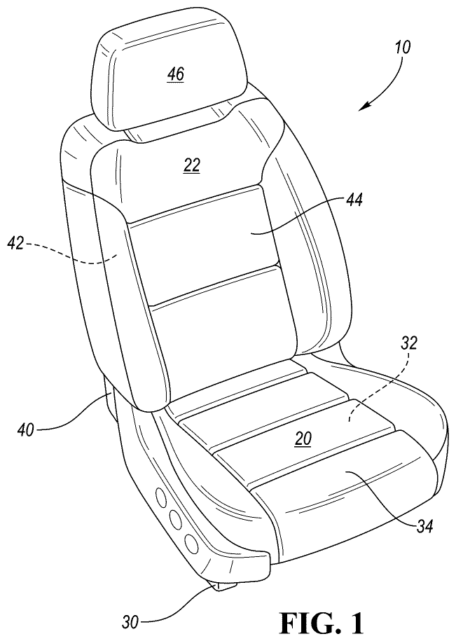

Referring to FIG. 1, an example of a seat assembly 10 is shown. In some embodiments, the seat assembly 10 is a vehicle seat assembly, such as for a land vehicle like a car, truck, bus, or the like, or for a non-land vehicle like aircraft or watercraft. For example, a seat assembly 10 for a land vehicle may be shaped and sized as a front row driver or passenger seat, a second, third, or other rear row seat, and may include bucket-style seats, bench-style seats, or other seat styles. Furthermore, the seat assembly 10 may be a non-stowable seat or a stowable seat that may be foldable and stowable in a cavity in the vehicle floor. Additionally, the seat assembly 10 may be configured for non-vehicle applications such as furniture.

In the configuration shown in FIG. 1, the seat assembly 10 includes a seat bottom 20 and a seat back 22. It is contemplated that the seat back 22 may be omitted in some configurations, such as when the seat assembly 10 is configured as a motorcycle seat or stool.

The seat bottom 20 is configured to receive a seated occupant and support the pelvis and thighs of the seat occupant. The seat bottom 20 includes a seat bottom frame 30, a cushion 32, and a trim cover 34.

The seat bottom frame 30 is a structure that supports the cushion 32. The seat bottom frame 30 includes one or more structural members and may be made of any suitable material, such as a metal alloy, polymeric material, fiber reinforced polymeric material, or combinations thereof. In some configurations, the seat bottom frame 30 includes a panel, seat pan, suspension mat, or suspension wires upon which the cushion 32 is disposed.

The cushion 32 is disposed on the seat bottom frame 30. The cushion 32 is made of a compliant material that supports the seat occupant and distributes load forces from the seat occupant to the seat bottom frame 30. The cushion 32 and associated methods of manufacture will be discussed in more detail below.

The trim cover 34 covers at least a portion of the cushion 32. In addition, the trim cover 34 provides one or more visible exterior surfaces of the seat back 22. The seat occupant may be disposed on the trim cover 34 when seated upon the seat assembly 10. The trim cover 34 is made of any suitable material or materials, such as fabric, leather, leatherette, vinyl, or combinations thereof. The trim cover 34 may include a plurality of trim panels that are assembled in any suitable manner, such as by fusing or stitching. The trim cover 34 is attached to the seat bottom frame 30, the cushion 32, or both. For example, the trim cover 34 may include trim attachment features that are attached to the seat bottom frame 30, the cushion 32, or both, to inhibit removal of the trim cover 34 and help conform the trim cover 34 to the contour of the seat bottom frame 30, the cushion 32, or both. The trim cover 34 may also be attached to an attachment pad as will be discussed in more detail below.

The seat back 22 is configured to support the back of a seated occupant. The seat back 22 is disposed adjacent to the seat bottom 20. For example, the seat back 22 may be disposed above the seat bottom 20 and near the rear side of the seat bottom 20. The seat back 22 extends in a generally upward direction away from the seat bottom 20. In some configurations, the seat back 22 is mounted to the seat bottom 20 and may be pivotable with respect to the seat bottom 20. In other configurations, the seat back 22 is not mounted to the seat bottom 20. For instance, a vehicle seat back may be mounted to the vehicle body structure, such as in some second row seat assemblies. The seat back 22 includes a seat back frame 40, a cushion 42, a trim cover 44, and optionally a head restraint 46.

The seat back frame 40 is a structure that supports the cushion 42. The seat back frame 40 includes one or more structural members and may be made of any suitable material, such as a metal alloy, polymeric material, fiber reinforced polymeric material, or combinations thereof. In some configurations, the seat back frame 40 includes a panel, pan, suspension mat, or suspension wires upon which the cushion 42 is disposed. It is also contemplated that the seat back frame 40 may be integrally formed with the seat bottom frame 30 in some configurations.

The cushion 42 is disposed on the seat back frame 40. The cushion 42 is made of a compliant material that supports the seat occupant and distributes load forces from the seat occupant to the seat back frame 40. It is contemplated that the cushion 42 may be integrally formed with the cushion 32 of the seat bottom 20 or may be separate from the cushion 32 of the seat bottom 20. The cushion 42 and associated methods of manufacture will be discussed in more detail below.

The trim cover 44 covers at least a portion of the cushion 42. In addition, the trim cover 44 provides one or more visible exterior surfaces of the seat back 22. The seat occupant may be disposed on the trim cover 44 when seated upon the seat assembly 10. The trim cover 44 is made of any suitable material or materials, such as fabric, leather, leatherette, vinyl, or combinations thereof. The trim cover 44 may include one trim panel or a plurality of trim panels that are assembled in any suitable manner, such as by fusing or stitching. The trim cover 44 is attached to the seat back frame 40, the cushion 42, or both. For example, the trim cover 44 may include trim attachment features that are attached to the seat back frame 40, the cushion 42, or both, to inhibit removal of the trim cover 44 and help conform the trim cover 44 to the contour of the seat back frame 40, the cushion 42, or both. The trim cover 44 may also be attached to an attachment pad as will be discussed in more detail below.

The head restraint 46, if provided, is configured to support the head of a seat occupant. The head restraint 46 is disposed at the top of the seat back 22 or at an end of the seat back 22 that is disposed opposite the seat bottom 20. The head restraint 46 may be moveable in one or more directions with respect to the seat back 22 or may be integrally formed with the seat back 22.

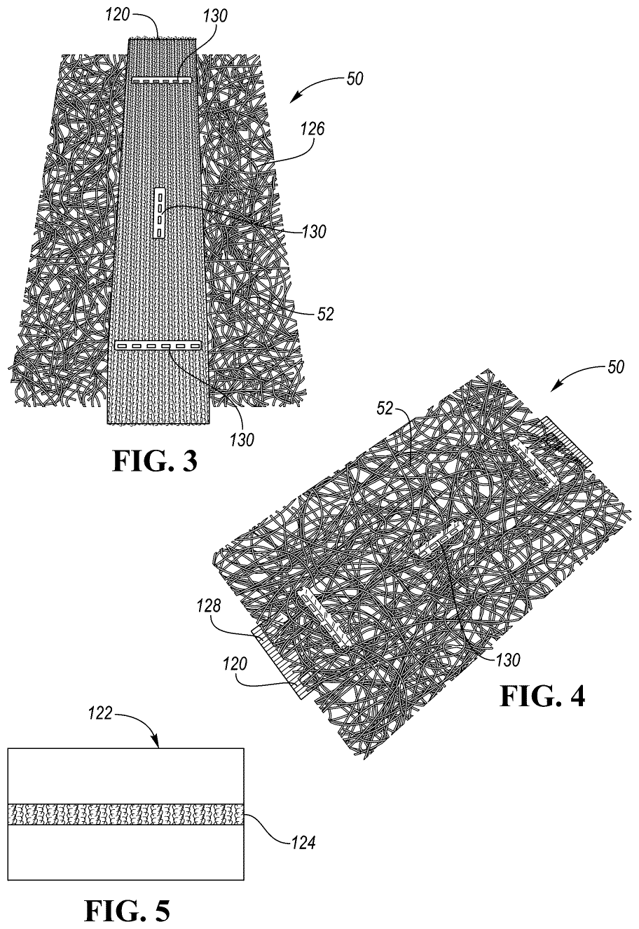

Referring to FIGS. 3 and 4, an example of a cushion 50 is shown. The cushion is generically designated with reference number 50 for convenience in reference. It is to be understood that the structure and description of the cushion 50 is applicable to the cushion 32 of the seat bottom 20, the cushion 42 of the seat back 22, or both.

The cushion 50 is a non-foam component or includes at least one non-foam component. The non-foam component is primarily referred to as a mesh member but may also be referred to as a stranded member, looped member, entangled member, filament mesh structure, mesh structure, stranded mesh, looped mesh, entangled mesh, or mesh cushion. In FIGS. 3 and 4, the cushion 50 is depicted as a non-foam component that does not include a foam component or foam material, such as urethane or polyurethane foam; however, it is contemplated that the cushion 50 may also include a foam component or foam material in addition to a non-foam component to provide additional cushioning or localized cushioning for a seat occupant. For example, foam material may be provided between the cushion 50 and a trim cover (e.g., trim cover 34, 44) that is disposed on the cushion 50, within the cushion 50, or combinations thereof. Reducing the amount of foam material that is provided with the cushion 50 or eliminating foam material from the cushion 50 reduces weight and may improve support and comfort of a seat occupant. In addition, eliminating foam material may facilitate recycling of the cushion 50.

The cushion 50 is described below in the context of a cushion 50 that does not include foam material. In this context, the cushion 50 is made of filaments 52 of polymeric material that are randomly looped, bent, curled, or entangled and are bonded together as will be discussed in more detail below. A filament 52 is directly bonded to another filament 52 rather than being indirectly bonded with a resin or other intermediate material.

The filaments 52, which may also be referred to as strands or threads, are made of any suitable material or materials. In some configurations, the filaments 52 are made of a polymeric material or thermoplastic material, such as a thermoplastic resin that is polyamide-based, polyester-based, polyimide-based, polyolefin-based (e.g., polypropylene-based, polyethylene-based, etc.), polystyrene-based, or combinations thereof. As one example, a polyethylene-based filament may be made of linear low density polyethylene (LLPDE). The filament material may be recyclable unlike foam material or more easily recycled than foam material. It is also contemplated that a filament 52 may comprise reinforcement fibers and that the reinforcement fibers may not be made of a thermoplastic material.

In some configurations, a filament 52 may be a monofilament that is made of a single material. In some configurations, a filament 52 is made of multiple materials. As an example, a filament 52 made of multiple materials may include a core that is made of a first thermoplastic material and a sheath that encircles the core and is made of a second thermoplastic material that differs from the first thermoplastic material. It is contemplated that the cushion 50 may include a combination of monofilaments and filaments that are made of multiple materials and are not monofilaments.

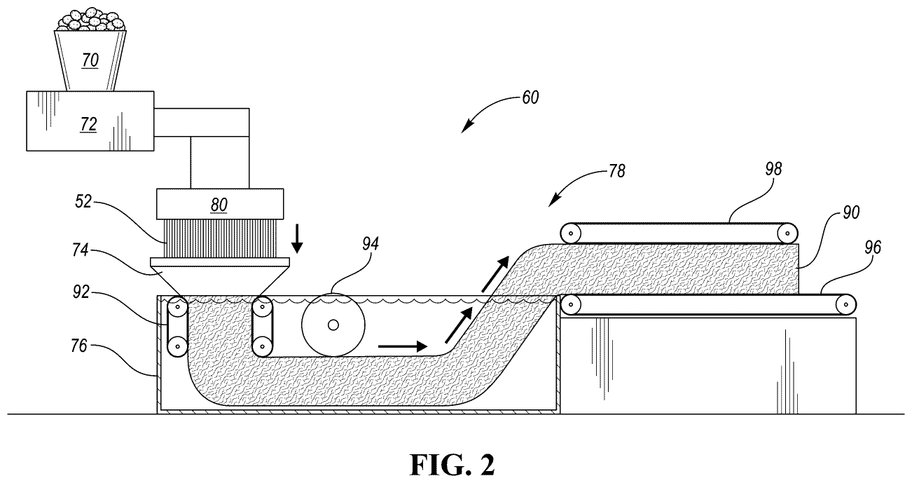

Filaments 52 that are randomly looped, bent, looped, curled, or entangled are bonded together where one filament 52 contacts another filament 52, thereby resulting in a lightweight, air permeable cushion (e.g., cushion 32 and/or 42) or mesh structure having openings or voids between the filaments 52. An example of a manufacturing system 60 of making a cushion or filament mesh structure is also shown in FIG. 2. In this example, the manufacturing system 60 includes a material supply 70, an extruder 72, and a funnel 74. The manufacturing system 60 also includes a cooling tank 76, and a material handling subsystem 78.

Referring to FIG. 2, the material supply 70 holds material stock that is to be extruded, such as solid beads, flakes, granules, pellets, or powder made of the material. In some configurations, the material supply 70 is configured as a container or hopper. The material supply 70 provides material stock to the extruder 72.

The extruder 72 melts the material stock and extrudes the material stock into a set of filaments 52. The extruder 72 may have any suitable configuration. In some configurations, the extruder 72 includes a barrel that receives a rotatable screw and heating elements. Rotation of the screw forces the material to move through the barrel and helps heat the material due to the friction generated as the screw rotates. The material exits the barrel under pressure and in a molten state and is transported under pressure to a die 80 of the extruder 72.

The die 80, which may also be referred to as a die plate or extrusion die, has multiple through holes or filament forming openings through which the molten material passes. A single filament 52 is extruded from each through hole. The filaments 52 fall downward from the die 80 under the force of gravity into the funnel 74.

The funnel 74 consolidates or groups the filaments 52 into a more compact arrangement in which the filaments bend, curl, or loop and filament 52 contacts and bonds to at least one other filament 52. The funnel 74 has an inlet opening or funnel inlet and an outlet opening or funnel outlet that is smaller than the funnel inlet. Individual separated filaments 52 enter the funnel inlet. The filaments 52 bend, curl, or loop and move into contact as they accumulate. The filaments 52 move through the funnel 74 or an intervening sheet that is disposed on the funnel 74 as the filaments 52 move toward the funnel outlet. Bonds are formed between filaments 52 at the points of contact while openings or voids between filaments 52 are present at other locations where one filament 52 does not contact or bond to another filament 52. The entangled and bonded filaments 52 pass through the funnel outlet of the funnel 74 and enter the cooling tank 76. For convenience in reference, the bonded filaments 52 are referred to as a mesh member or filament mesh structure 90.

The cooling tank 76 holds a liquid, such as water or a mixture of water and another fluid. The liquid in the cooling tank 76 helps support the entangled and bonded filaments 52 to limit further compacting or consolidation of the filaments 52 into a less open or less porous arrangement and maintains a desired porosity and density of the filament mesh structure 90. Thus, the liquid provides some buoyancy or resistance that can result in additional bending, curling, or looping of the filaments 52 adjacent to the surface of the liquid or within the funnel 74 to further build the filament mesh structure 90. The liquid also cools the filaments 52 when the filaments 52 are in the liquid. For instance, the liquid cools the filaments 52 from the outside to solidify the filaments 52 and prevent the filaments 52 from bonding at additional locations. At this point, the filaments 52 are relatively stiff and no longer in a plastic state and thus generally maintain a shape and are not moldable or reformable without being reheated.

The material handling subsystem 78 transports the filament mesh structure 90 through the cooling tank 76. The material handling subsystem 78 includes various rollers and conveyors that help move the filament mesh structure 90 through the liquid and out of the liquid. In some configurations, a tractor conveyor 92 is provided in the cooling tank 76 to help pull the filament mesh structure 90 away from the funnel 74 and to counter buoyancy of the filaments 52.

One or more other rollers, such as roller 94, keep the filament mesh structure 90 submerged in the liquid and guide the filament mesh structure 90 through the cooling tank 76. For example, the roller 94 may guide the filament mesh structure 90 toward a conveyor belt 96 and shaker table 98 that are disposed outside of the cooling tank 76. The shaker table 98 shakes the filament mesh structure 90 while it is on the conveyor belt 96 to remove liquid. Alternatively, or in addition, the filament mesh structure 90 may be squeezed to remove liquid, air may be blown toward the filament mesh structure 90 to help remove liquid from the filament mesh structure 90, or both. It is also contemplated that the filament mesh structure 90 may also be allowed to drip dry, or dry in ambient air.

The manufacturing system 60 described above is a continuous flow process in which the filament mesh structure 90 is formed as a continuous structure when filament extrusion is not interrupted. Further processing of the filament mesh structure 90 is provided after exiting the cooling tank 76 to cut the filament mesh structure 90 into individual pieces or blanks for individual cushions. Such processing is conducted by a cutting subsystem of the manufacturing system 60. The cutting subsystem may be of any suitable type. For instance, the cutting subsystem may employ a blade, knife, hot knife, saw, fluid jet, or the like to cut the filaments 52 of the filament mesh structure 90 into a blank. The cutting subsystem may be used to shape or contour the blank. It is also contemplated that a blank may be further shaped or contoured with other manufacturing processes, such as molding of the entire blank or a portion thereof.

With the above process, the cushion 50 may be formed of a set of filaments 52, wherein at least two members of the set of filaments 52 are looped and bonded to each other. In one or more embodiments, each member of the set of filaments 52 is looped and bonded to at least one other member of the set of filaments 52.

Referring again to FIGS. 3 and 4, the example of the cushion 50 is shown, which is provided by a portion 50 or a blank 50 of the filament mesh structure 90 comprising filaments 52. A support, such as a fastener strip 120, is in contact with, and attached to, the cushion 50. In some embodiments, the fastener strip 120 is a hook fastener strip. A hook fastener strip comprises a strip of fabric featuring a plurality of polymeric hooks. In other configurations, the fastener strip 120 is a loop fastener strip. A loop fastener strip comprises a strip of fabric featuring a plurality of polymeric loops. When the hook strip fabric is pressed against the loop strip fabric, the hooks engage with the loops, forming a secure bond that is separable when peeled.

In other embodiments the fastener strip 120 takes an alternative fastener form such as a strip, that varies by material or fabric, and may include a clip, a lengthwise fastener, a zipper, cord insertion, a flex hook fastener, a dual prong fastener, a peg fastener, a series of these fasteners, or the like.

The fastener strip 120 provides a first fastener in a fastener assembly. FIG. 5 illustrates a trim component 122 according to another embodiment. According to some embodiments, the trim component 122 is a trim cover, such as the trim cover 34 or the trim cover 44. According to other embodiments, the trim component 122 is an actuator, such as a bladder assembly, a heat transfer assembly, a heater pad, or any other suitable trim component that is attachable to the cushion 50.

A second fastener strip 124 is attached to an underside of the trim component 122, where the second fastener strip 124 will be concealed upon assembly. The second fastener strip 124 cooperates with the first fastener strip 120 to attach the trim component 122 to the cushion 50. The second fastener strip 124 is attached to the trim component 122 by any suitable fastener, such as welding, stitching, adhesives, coextrusion, insert molding, or the like. In the embodiment wherein the trim component 122 is a trim cover 122, the second fastener strip 124 permits a seamless attachment of the trim cover 122 to the cushion 50 without an externally visible seam. Suitable fastening is permitted along a concave cushion surface without requiring trenches within the cushion 50. By utilizing lengthwise strip fasteners 120, 124, adhesives can be eliminated, which may otherwise generate an audible noise during the application and withdrawal of a load, associated with seating and removal of an occupant.

According to one embodiment the cushion 50 and the first fastener strip 120 each comprise a similar recyclable material such as a thermoplastic resin that is polyamide-based, polyester-based, polyimide-based, polyolefin-based, polypropylene-based, polyethylene-based, polystyrene-based, or combinations thereof; as one example, a polyethylene-based filament mesh member may be made of linear low-density polyethylene (LLPDE)). The similar materials omit an adhesive and permit recycling of the similar materials. Likewise, the second fastener strip 124 may be formed from a similar recyclable material. Even further, the trim component 122 may also be formed from the similar recyclable material.

Referring again to FIGS. 3 and 4, the cushion 50 and the first fastener strip 120 are joined together, at least partially, along mating surfaces 126, 128 between the cushion 50 and the first fastener strip 120. A plurality of welds 130 is formed at least partially along the mating surfaces 126, 128 of the cushion 50 and the first fastener strip 120. The welds 130 may be formed at least partially through the cushion 50 as shown in FIG. 4.

The welds 130 of the cushion 50 and the first fastener strip 120 result in a strong, homogeneous bond. In the configuration of the first fastener strip 120 as being one of a hook fastener strip and a loop fastener strip, sufficient fastener strip material is preserved around the welds 130 so that the hook material readily bonds to the loop material.

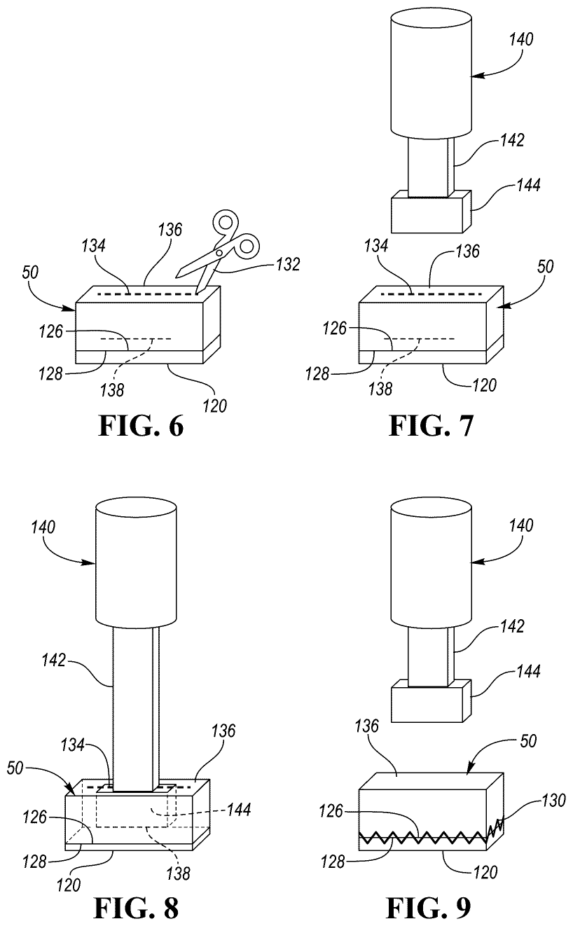

Referring to FIG. 6, the cushion 50 and the fastener strip 120 are stacked upon each other. The mating surfaces 126, 128 of the cushion 50 and the fastener strip 120 are in contact. A cutting tool 132 is utilized to create an aperture 134 in the cushion 50. The cutting tool 132 is illustrated schematically as a pair of scissors. However, the cutting tool 132 may be any suitable type, such as a blade, knife, hot knife, saw, fluid jet, or the like. The cutting tool 132 may be provided in the cutting subsystem of the manufacturing system 60. Alternatively, the cutting tool 132 may be provided downstream in a subsequent, or separate manufacturing operation.

In FIG. 6, the aperture 134 is formed as a slit 134 through a base surface 136 of the cushion 50 that is spaced apart from the mating surface 126. The slit 134 is formed to a blind depth 138 that is spaced apart from the mating surface 126. The spacing of the blind depth 138 to the mating surface is a dimension suitable for performing a welding operation to the cushion 50 and the first fastener strip 120. Additionally, the slit 134 is sized to receive a portion of a welding tool 140 for performing the welding operation.

FIG. 7 illustrates the cushion 50 stacked upon the first fastener strip 120. The cushion 50 and the first fastener strip 120 are presented beneath the welding tool 140. The welding tool 140 may be automated or operated manually. According to one embodiment, the welding tool 140 is an ultrasonic welding tool 140. Any welding tool 140 may be employed, such as a heated welder or a friction stir welder. The welding tool 140 includes a welder arm 142 with a weld tip 144 at a distal end of the welder arm 142.

In FIG. 8, the welder arm 142 extends the weld tip 144 into the slit 134 in the base surface 136 into contact with the blind depth 138 of the cushion 50. According to an embodiment, the weld tip 144 may be utilized to compress a portion of the cushion 50 to enhance contact between the cushion 50 and the first fastener strip 120. The weld tip 144 is also vibrated ultrasonically under the pressure of the welder arm 142 to create friction between the cushion 50 and the first fastener strip 120 to melt the cushion 50 and the first fastener strip 120 at the mating surfaces 126, 128.

In FIG. 9, the melted mating surfaces 126, 128 of the cushion 50 and the first fastener strip 120 cool to solidify and form the weld 130. The weld arm 142 is retracted to permit the cushion 50 to expand as the welded cushion 50. The weld 130 includes a consistent depth, such as a quantity of strands 52 beyond the mating surface 128. The quantity of strands 52 may be up to three strands 52, or two millimeters, for some examples. The consistent depth of the weld 130 is more repeatable than an adhesive, which often drips beyond the mating surfaces, and creates a denser and inconsistent bond beyond the lower mating surface. By omitting adhesives, the cushion 50 is formed from one consistent material, thereby simplifying recyclability. Additionally, the weld 130 provides a flexibility that is less rigid in comparison to comparable adhesive bond.

The welded cushion 50 provides a lightweight, sustainable comfort solution for seat assemblies 10, thereby reducing vehicle weight, while maintaining occupant support, to reduce cost and enhance fuel efficiency. The strands 52 of the cushion 50 provide a reduced surface area for bonding. However, compressing and/or welding the cushion 50 enhances the density and area of the mating surfaces 126 to create the weld 130, which is stronger than adhesives in applicable testing, such as shear resistance. Although one cushion 50 and one fastener strip 120 are illustrated welded together, any number of cushions 50, or cushion portions or segments 50, and fastener strips 120 and any number of welds 130 may be employed to fabricate various cushions 50.

According to another embodiment, the aperture 134 may be sealed by a weld, adhesive, or the like. The sealed aperture 134 may be employed to return the cushion 50 to a solid configuration akin to the configuration prior to the cutting operation of FIG. 6.

Various parameters of the welding process can be varied for various specifications or applications. For example, the power, voltage, and current of the welding tool 140 can be adjusted to adjust the performance of the weld 130. Likewise, adjustment of proximity of a point of contact of the weld tip 144 and the cushion 50, and a pressure applied to the cushion 50 by extension of the weld arm 142 can also vary the weld 130 performance. The time of the weld 130 can also be varied for varying the performance. At the welder tip 144, a frequency of the tip 144 can be varied for a varied weld performance. Additionally, a shape of the welder tip 144 can be adjusted to adjust performance to result in a surface weld, a point weld, or the like.

Various configurations of the cushion mating surface 126 may also be employed to achieve different mating configurations. For example, the cushion mating surface 126 may include a skin layer. Additionally, the weld 130 can be varied by varying the material of the cushion 50, adjusting an area of the mating surfaces 126, 128, or changing a quantity of welds 130. Various materials may include polyethylene, linear low-density polyethylene, high density polyethylene, polypropylene, polycarbonate, thermoplastic polyester elastomer, acrylonitrile butadiene styrene, polyoxymethylene, or the like.

According to a first clause, alone or in combination with any of the successive clauses, a cushion is provided with a filament mesh member comprising a set of filaments of thermoplastic material, wherein each member of the set of filaments is looped and bonded to at least one other member of the set of filaments. A fastener strip is welded to the filament mesh member.

According to a second clause, the cushion of any of the preceding or successive clauses is provided, wherein the fastener comprises a hook fastener or a loop fastener.

According to a third clause, the cushion of any of the preceding or successive clauses in provided, wherein the fastener further comprises a hook fastener.

According to a fourth clause, the cushion of any of the preceding or successive clauses is provided, wherein the fastener is further defined as a first fastener, and wherein the cushion is further provided with a second fastener fastened to the first fastener.

According to a fifth clause, the cushion of any of the preceding or successive clauses is provided, wherein the second fastener further comprises a loop fastener.

According to a sixth clause, the cushion of any of the preceding or successive clauses is provided with a trim component attached to the second fastener.

According to a seventh clause, the cushion of any of the preceding or successive clauses is provided with a trim cover disposed at least partially over an exterior of the filament mesh member.

According to an eighth clause, the cushion of any of the preceding or successive clauses is provided, wherein the fastener and the filament mesh member each comprise a similar recyclable material.

According to a ninth clause, the cushion of any of the preceding or successive clauses is provided, wherein an aperture is formed into a first surface of the filament mesh member, spaced apart from the fastener.

According to a tenth clause, a seat assembly is provided with a seat frame, and the cushion of any of the preceding or successive clauses is provided, attached to the frame.

According to an eleventh clause, the seat assembly of the preceding clause is further provided, wherein the fastener strip is further defined as a first fastener. The cushion is further provided with a second fastener fastened to the first fastener. The seat assembly is further provided with a trim component attached to the second fastener. The trim component is further provided with a trim cover disposed at least partially over an exterior of the filament mesh member. The trim cover at least partially covers the seat frame.

According to a twelfth clause, a cushion is provided, alone or in combination with any of the preceding or successive clauses. A filament mesh member is proved with a plurality of filaments of thermoplastic material, wherein each member of the set of filaments is looped and bonded to at least one other member of the set of filaments, with an aperture formed into a first surface of the filament mesh member. A support is welded to the filament mesh member at a second surface spaced apart from the first surface.

According to a thirteenth clause, the cushion of any of the preceding or successive clauses is provided, wherein the aperture is formed to a blind depth.

According to a fourteenth clause, the cushion of any of the preceding or successive clauses is provided, wherein the blind depth is spaced apart from the support.

According to a fifteenth clause, the cushion of any of the preceding or successive clauses is provided, wherein the aperture is formed as a slit.

According a sixteenth clause, the cushion of any of the preceding clauses is provided, wherein the aperture is sealed.

According to a seventeenth clause, a method is provided, alone or in combination with any of the successive clauses, by forming a filament mesh member with a set of filaments of thermoplastic material, wherein each member of the set of filaments is looped and bonded to at least one other member of the set of filaments, with an aperture formed into a first surface of the filament mesh member. A welding tool is inserted into the aperture of the filament mesh member. A region of the filament mesh member is welded.

According to an eighteenth clause, the method of any of the preceding or successive clauses is provided by welding a support to the region of the filament mesh member.

According to a nineteenth clause, the method of any of the preceding or successive clauses is provided by retracting the welding tool after welding the filament mesh member.

According to a twentieth clause, a seat cushion is formed by the method of any of the preceding clauses.

While various embodiments are described above, it is not intended that these embodiments describe all possible forms according to the disclosure. In that regard, the words used in the specification are words of description rather than limitation, and it is understood that various changes may be made without departing from the spirit and scope of the disclosure. Additionally, the features of various parameters implementing embodiments may be combined to form further embodiments according to the disclosure.

What is claimed is:

1. A cushion comprising:
a filament mesh member comprising a set of filaments of thermoplastic material, wherein each member of the set of filaments is looped and bonded to at least one other member of the set of filaments; and
a fastener strip welded to the filament mesh member.

2. The cushion of claim 1, wherein the fastener strip comprises a hook fastener or a loop fastener.

3. The cushion of claim 1, wherein the fastener strip further comprises a hook fastener.

4. The cushion of claim 1, wherein the fastener strip is further defined as a first fastener strip, and
wherein the cushion further comprises a second fastener strip fastened to the first fastener strip.

5. The cushion of claim 4, wherein the second fastener strip further comprises a loop fastener strip.

6. The cushion of claim 4, further comprising a trim component attached to the second fastener strip.

7. The cushion of claim 6, wherein the trim component further comprises a trim cover disposed at least partially over an exterior of the filament mesh member.

8. The cushion of claim 1, wherein the fastener strip and the filament mesh member each comprise a similar recyclable material.

9. The cushion of claim 1, wherein an aperture is formed into a first surface of the filament mesh member, spaced apart from the fastener strip.

10. A seat assembly comprising:
a seat frame; and
the cushion according to claim 1, attached to the frame.

11. The seat assembly of claim 10, wherein the fastener strip is further defined as a first fastener strip;
wherein the cushion further comprises a second fastener strip fastened to the first fastener strip;
wherein the seat assembly further comprises a trim component attached to the second fastener strip;
wherein the trim component further comprises a trim cover disposed at least partially over an exterior of the filament mesh member; and
wherein the trim cover at least partially covers the seat frame.

12. A cushion comprising:
a filament mesh member comprising a plurality of filaments of thermoplastic material, wherein each member of the set of filaments is looped and bonded to at least one other member of the set of filaments, with an aperture formed into a first surface of the filament mesh member; and
a support welded to the filament mesh member at a second surface spaced apart from the first surface.

13. The cushion of claim 12, wherein the aperture is formed to a blind depth.

14. The cushion of claim 13, wherein the blind depth is spaced apart from the support.

15. The cushion of claim 12, wherein the aperture is formed as a slit.

16. The cushion of claim 12, wherein the aperture is sealed.

17. A method comprising:
forming a filament mesh member comprising a set of filaments of thermoplastic material, wherein each member of the set of filaments is looped and bonded to at least one other member of the set of filaments, with an aperture formed into a first surface of the filament mesh member; and
inserting a welding tool into the aperture of the filament mesh member; and
welding a region of the filament mesh member.

18. The method of claim 17, further comprising welding a support to the region of the filament mesh member.

19. The method of claim 17, further comprising retracting the welding tool after welding the filament mesh member.

20. A seat cushion formed by the method of claim 17.
